(19) United States
(12) Patent Application Publication
(10) Pub. No.: US 2008/0196102 A1
(43) Pub. Date: Aug. 14, 2008

(54) Device, system and method for use of micro-policies in intrusion detection/prevention

(75) Inventor: Martin Frederick Roesch, Eldersburg, MD (US)

Correspondence Address: POSZ LAW GROUP, PLC, 12040 SOUTH LAKES DRIVE, SUITE 101, RESTON, VA, 20191, US

(73) Assignee: Sourcefire, Inc., Columbia, MD (US)

(21) Appl. No.: 11/905,980

(22) Filed: Oct. 5, 2007

Related U.S. Application Data
(60) Provisional application No. 60/849,763, filed on Oct. 6, 2006.

(51) Int. Cl. G06F 21/06

(52) U.S. Cl. 726/23

(57) ABSTRACT

A method, computer system and/or computer readable medium, associates attack detection/prevention rules with a target in a communication network. The attack detection/prevention rules are provided for the target without differentiation as to flows. A particular flow is associated with a transmission destination, a port number, a platform, a network service, or a client application on the target. A micro-policy is bound to a target of the particular flow based on monitored transmissions. The micro-policy that was bound to the target of the particular flow, is applied to the target to detect an intrusion in the particular flow. Binding the micro-policy includes selecting, as the micro-policy, only rules in the attack detection/prevention rules that are specific to the port number, the protocol, the family of machine, and the version associated with the particular flow, and associating only the selected rules of the micro-policy with the target of the particular flow.

### CROSS-REFERENCE TO RELATED APPLICATIONS

This application claims the benefit of U.S. Provisional Application Ser. No. 60/849,763, filed Oct. 6, 2006, which is expressly incorporated herein by reference.

### TECHNICAL FIELD

The technical field relates in general to network traffic analysis, and more specifically to determining rules to be applied in connection with intrusion detection/prevention.

### BACKGROUND

Previously, network intrusion detection technologies such as SNORT sensors did not have any context (knowledge of the composition of hosts communicating on the network) to correctly or precisely analyze communication traffic for attacks and model the state of the end-points involved in a network session. Such a system would just notice, for example, an HTTP (hyper text transfer protocol) attack, and would not know the client's browser or operating system brand, or the web server's brand or operating system or vendor and version of the server software itself, and consequently could not know if an attack would succeed or not, nor could they normalize the HTTP protocol encodings properly for the clients and servers involved in the conversation. This is a problem that could lead to false positives due to misapplication of detection rules. Furthermore, because of the way that operating systems and server software are implemented it is possible to take advantage of differences between them to evade the intrusion detection technology. Attackers know that if they can gather sufficient information about their targets then they can take advantage of those implementation differences to bypass the intrusion detection engine.

In order to properly model the network traffic it is necessary to eliminate the informational disparity between the attacker and the intrusion detection technology by discovering assets on the network and their composition. The way that this discovery function is traditionally performed is by using active scanning mechanisms to interrogate the assets on the network. Active scanning of a network can sometimes disrupt operations of the devices on that network and is usually not done in a timely fashion but in a scheduled or ad hoc manner instead. A more efficient method for discovery of network assets is to use a passive network discovery system such as the RNA technology available from Sourcefire.

### SUMMARY

Accordingly, if an intrusion detection technology is to utilize data about the network environment in order to increase the fidelity of its analysis as well as reducing the opportunities for false positives or evasion, the data about the operational network environment must be updated in real-time.

Therefore, one or more embodiments provide systems, computer readable mediums, and methods performed in an intrusion detection/prevention system, for associating attack detection/prevention rules and traffic modeling configuration with a target in a communication network, for a particular flow, wherein the attack detection/prevention rules are provided for the target without differentiation as to flows, wherein a particular flow is associated with a transmission destination, a port number, a platform, a network service, or a client application on the target. Transmissions in a particular flow are monitored. A micro-policy is bound to the particular flow based on the known attributes of a target. The micro-policy is applied to traffic to the flow to detect attacks in the particular flow according to the micro-policy rules which were bound to the target of the particular flow. Binding the micro-policy includes selecting, as the micro-policy, only rules in the attack detection/prevention rules that are specific to the port number, the protocol, the family of software, and the version associated with the particular flow, and associating only the selected rules of the micro-policy with the target of the particular flow.

Other embodiments provide methods, computer systems, and computer readable mediums for detecting or preventing intrusions, for use with attack detection/prevention rules, with a target in the communication network, for a particular flow, wherein the attack detection/prevention rules are provided for the target without differentiation as to flows, wherein a particular flow is associated with a transmission destination, a port number, a platform, a network service, or a client application on the target. A monitor unit is configured to facilitate monitoring transmissions in a particular flow. A binder unit is configured for binding a micro-policy to a flow tracking subsystem within the intrusion detection system involving a particular target based on the target's attributes. An application unit configured to facilitate applying the micro-policy to the target traffic to detect/prevent an intrusion in the particular flow according to the micro-policy rules that were bound to the target of the particular flow. Binding the micro-policy includes selecting, as the micro-policy, only rules in the attack detection/prevention rules that are specific to the port number, the protocol, the family of software, and the version associated with the particular flow, and associating only the selected rules of the micro-policy with the particular flow involving the target having those attributes.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating a simplified and representative architecture associated with intrusion detection/prevention utilizing micro-policies;

FIG. 2 is a functional block diagram illustrating a runtime architecture associated with intrusion detection/prevention utilizing micro-policies;

FIG. 3 is a block diagram illustrating components of a target based intrusion detection/prevention system utilizing micro-policies;

FIG. 4 is a block diagram illustrating portions of an exemplary computer system;

FIG. 5 is a block diagram illustrating TCP/IP (transmission control protocol/Internet protocol) layer processing;

FIG. 6 is a block diagram illustrating portions of an Internet protocol (IP) header in a segment;

FIG. 7 is a block diagram illustrating portions of a TCP (transmission control protocol) header in a segment; and

FIG. 8 is a flow chart illustrating an exemplary procedure for detecting/preventing intrusions.

### DETAILED DESCRIPTION

In overview, the present disclosure concerns analysis of network traffic on communication networks, often referred to as packet switching networks, which support communication from wireless and/or wire line devices to a destination. Communications on such communication networks may be analyzed for intrusion detection/prevention according to various rules. More particularly, various inventive concepts and principles are embodied in systems, devices, and methods therein for determining rules to be used for intrusion detection/prevention, optionally in connection with intrusion detection/prevention systems.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

Relational terms such as first and second, and the like, if any, are used herein solely to distinguish one from another entity, item, or action without necessarily requiring or implying any actual such relationship or order between such entities, items or actions. Some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts, further discussion of such software and ICs, if any, will be limited to the essentials with respect to the principles and concepts used by the exemplary embodiments.

Target-based asset data significantly increases the knowledge of server and client application vendors and versions as well as operating systems of the devices involved in a session on the communication network and allows much more accurate modeling of the state of the end-points involved in a particular flow so as to more accurately analyze protocols for attack detection. Using this data, a detection engine of an intrusion detection/prevention system (IDS), for example, may be configured to automatically tune itself, for example in real-time based on the composition of assets on the network. By self-tuning, the IDS reduces the workload on security administrators while increasing the quality of its output and reducing the chance of evasion by a malicious attacker. This cuts down on false alerts, saves database storage, saves analysts from reviewing false alerts, and generally reduces the information managed, yet increases the quality of that information and reduces the incident response timeline. Security teams that employ this technology may have more resources able to focus on fewer issues, either freeing up time and resources, or just better focusing those resources on true alerts. This can provide huge increases in efficiency and reduces operating costs of the security technology.

In addition, the use of passive network discovery methods avoids the operational disruption of the network and does not consume any network bandwidth to determine network asset attributes while at the same time providing real-time intelligence about network assets.

Furthermore, the use of a local passive network discovery sensor, such as SOURCEFIRE RNA (real-time network analysis) software, provides a high quality contextual understanding of the attributes of network resources. The precise asset information derived from RNA software provides a foundation to implement a self-tuning system, which can reduce successful evasions and minimize false alerts.
Once a passive network discovery infrastructure such as RNA is available, the data it produces can be leveraged to radically improve the efficiency and effectiveness of network intrusion detection and prevention technology. If network asset compositional data is available, a properly constructed intrusion detection engine can use this data to automatically select the appropriate analysis functionality for any given network flow it monitors based on the knowledge of the possible attacks that may be carried out against the end-points in the flow. Once this selection capability is available, the opportunities to evade the intrusion detection engine by an attacker leveraging informational superiority over the sensor virtually disappears. At the same time, only relevant analytics will be applied to the conversation so false positives will be virtually eliminated. The target-based information can include, for example, the target's IP (Internet protocol) address, operating system, services and client applications.

As the number of attack detection rules increases, applying those rules in a more precise fashion will mitigate potential slow-downs of the intrusion sensor technology. If the number of rules applied to each flow cannot be constrained in this fashion it will be very difficult to maintain real-time intrusion detection and prevention performance in the face of ever increasing network performance. RNA is a known processing technology that can identify characteristics of a target, such as its operating system.

One solution to these and other problems discussed above is to have the IDS “tune” itself. A fast pattern matcher with a subset of possible detections can utilize a finite state machine to determine the rules that are relevant to a particular target. Examples of appropriate fast pattern matchers include PatSearch, the Rete algorithm, and others.

One way for the IDS to associate the correct rules with the target utilizes micro-policies. A micro-policy can be associated with a particular port and/or a particular platform, network service or client application. A port micro-policy can include target-based information, such as the port number, the protocol, the family of software, and the version, and/or other target-based information; the context associated with the port; and the rules to be applied. A platform micro-policy can include target-based information, such as the platform, the version, and/or other target-based information; the context associated with the operating system's TCP/IP (transmission control protocol/Internet protocol) implementation; and the rules to be applied. A particular micro-policy can then be bound to a particular target. Optionally, the binding can be dynamic, that is, performed on an as-needed basis or when a new target is presented.

One or more embodiments of the micro-policies utilizes an attribute table indicating, for example, unique network address (for example ip address or Ethernet address), operating system, protocol, and the like; and includes an indication of the micro-policy that is to be bound. Accordingly, traffic incoming to the ip address can be received by a dispatcher, which can address the attribute table by ip address, locate the micro-policy that is to be bound to the target, and bind the micro-policy to the target. Then, the IDS need only check the micro-policies that are relevant to a flow associated with that target.

An overview of an example embodiment is discussed in the following. This example Target Based Architecture includes three tiers: (1) RNA (or other technology which identifies characteristics of the target), (2) Management System, and (3) traffic monitor, for example a SNORT Sensor.

The RNA can perform network discovery, by passively collecting target-based information on network hosts and sending that data to the Management System. The network discovery can alternatively be active, for example by using a scanning tool to probe systems (this technique studies how systems respond to probes to discover information), or by including user provided information about network assets. RNA is an example of network discovery sensors. Other passice or active network discovery sensors may be used.

The Management System: (1) collects Target-Based Data from the RNA; (2) sends target-based data to a traffic monitor, for example, SNORT sensors; and (3) modifies rule policies to correspond to best rule sets based on target based information (for instance, if specific servers or applications are found, rules to detect attacks on those are included).

The SNORT sensor or other traffic monitor can use the target-based information from the Management System. The sensor monitors traffic to/from the target. The sensor can apply detection policies and rules based on target-based information in various areas. For example, detection policies and rules can be applied in: (1) ip fragmentation which can use host attributes to do ip reassembly; (2) tcp (transmission control protocol) streaming which can use target based attributes for tcp sequencing and reassembly; and (3) rule selection can use target based attributes to select rule groups for specific protocols.

Target-based information may include various host attributes, for example, one or more of:

Host Target based Attributes (non exhaustive, defined and discovered by, e.g., RNA)

IP-address

TTL

operating system (=linux-2.4.16/windows-nt/windows-xp/bsd/solaris, . . . ),
family(=red hat, ubuntu, Suse, . . . )
version(=8,9,10, . . . )
application services(=web server,ftp server, mail server, . . . )
family(=microsoft,mozilla,sun,netscape, . . . )
versions( . . . )

application clients(=web browser, mail client, instant messenger, . . . )
family(microsoft,mozilla, . . . )
version( . . . )

Most hosts are either a service provider (server) or a client; some may in fact perform both functions. Much of the collection of target-based information can be performed by using a conventional traffic monitor, for example RNA. The RNA sensors are local to the network that they are monitoring. This allows the RNA sensors to understand clearly what the local systems look like on the network. SNORT software, when in IDS mode, can be passively monitoring the traffic at a switch, which may be some distance from the local network. Thus RNA can provide an intimate knowledge of the local network's characteristics. Alternatively, or in addition to the automated collection, the target-based information can be manually entered and/or modified.

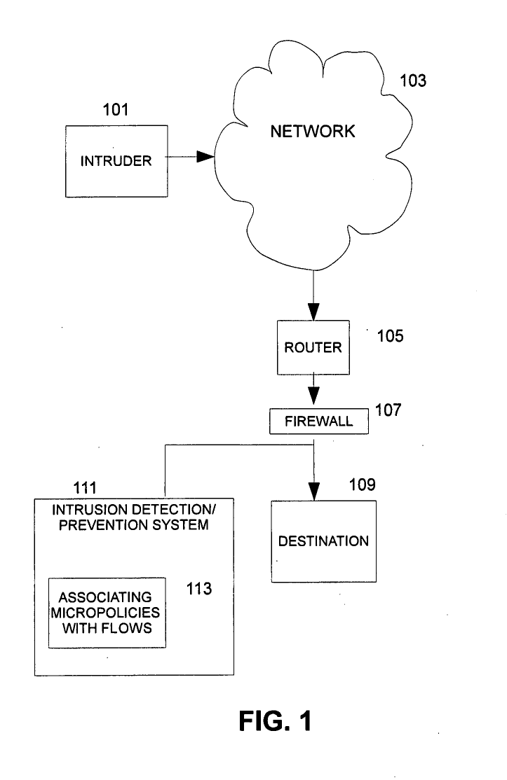

Referring now to FIG. 1, a block diagram illustrating a simplified and representative architecture associated with intrusion detection/prevention utilizing micro-policies will be discussed and described. In the illustration, an intruder 101 (such as a computer system) transmits packets to a destination 109. In this example, the packets are transmitted via a network 103, a router 105, and a firewall 107 to the destination 109. The packets to the destination 109 can be monitored in accordance with well known techniques by an intrusion detection/prevention system (IDS) 111, such as with a sensor. Although this illustration provides a sensor behind the firewall 107, the sensor can be provided anywhere before the destination 109. Alternatively, the intrusion detection/prevention system 111 can be provided in-line with the destination 109, or can be incorporated into the destination 109. The intrusion detection/prevention system can include a function 113 for associating a micro-policy with a flow (loosely, a series of packets in a single conversation), as further discussed herein. A broad selection of intrusion detection/prevention rules are provided to the IDS 111 using conventional techniques, for use in determining whether there is an intruder 101. Typically, a rule defines behaviors for detecting an intrusion and/or an action to take to respond to/prevent an intrusion; rules are well understood in the industry.

Because the micro-policies indicate only rules that are specific to a particular flow, and because a micro-policy is bound to a particular flow, the IDS can limit its examination of a particular flow to only the rules in the micro-policy that is bound to that flow. Accordingly, the applying of the micro-policy to the target to detect an intrusion can include forwarding the rules in the micro-policy to an intrusion detection/prevention engine.

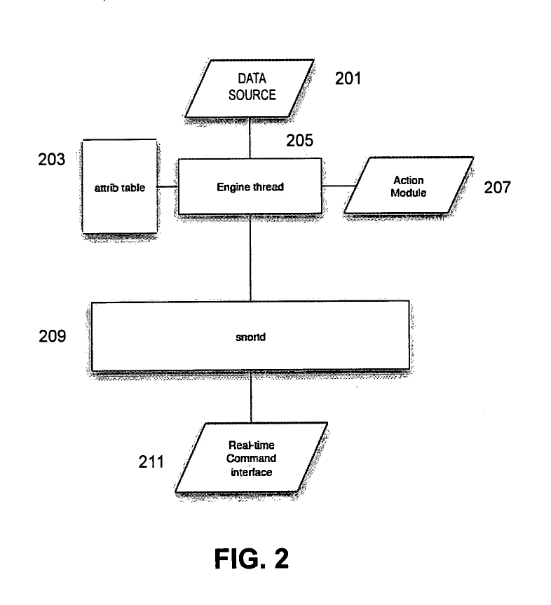

Referring now to FIG. 2, a functional block diagram illustrating a runtime architecture associated with intrusion detection/prevention utilizing micro-policies will be discussed and described. Included in this illustration are a data source 201, an attribute table 203, an engine thread 205, an action module 207, a sensor process 209 (here represented by “Snortd”), and a real-time command interface 211.

The data source 201 obtains input to be inspected for intrusion detection/prevention, that is, packets that are received.

The attribute table 203 includes potential attributes of targets, for example ip address, operating system, protocol, together with any other target-based information (discussed above) and/or other attributes that may be used to determine an appropriate micro-policy. The attributes in the attribute table 203 were previously identified, for example by the target-based data collection by the RNA, and/or by a manually entered table. The attribute table 203 can be addressed conveniently based on ip address (as illustrated), or Ethernet address, or other unique network address.

The action module 207 contains actions that are to be performed in the event that an attempted intrusion incident is detected, for example, log the incident, send an alert of the incident, lock out an ip address, shut down a firewall, and the like, as is understood in the industry.

The engine thread 205 is a thread that processes packets. Multiple engine threads 205 can be provided so that packets can be processed by different engine threads 205. The packets are provided to the engine thread 205. The engine thread 205 also references the attribute table 203 and the action module 207. In this example, the engine thread 205 determines the packets that belong to a flow, selects a micro-policy to be applied to the flow based on the attribute table, and provides the rules in the micro-policy to the sensor process 209.

The sensor process 209 (here represented by “Snortd”, a SNORT sensor daemon (that is, a traffic monitor running as a background process)) applied the rules against the incoming packets. In this embodiment, it applies just the rules in the micro-policy against packets in a particular flow, where the micro-policy has only rules that are specific to the port number, the protocol, the family of machine, and the version associated with the particular flow. Different micro-policies can be applied to different flows.

The real-time command interface 211 interacts with a user, and can receive commands to be input to the sensor 209, for example to input rules if not supplied automatically, to input attributes into the attribute table if not determined automatically (e.g., by RNA), and for other commands such as granularity of information to be logged.

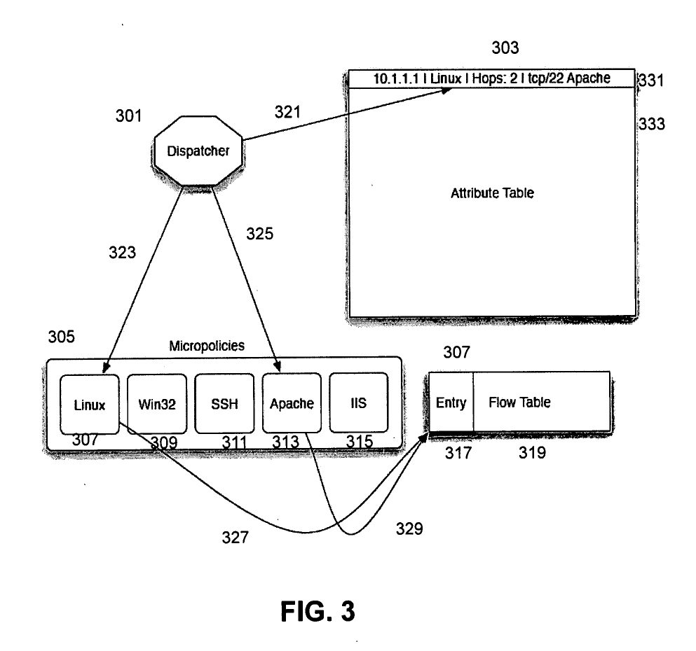

Referring now to FIG. 3, a block diagram illustrating components of a target based intrusion detection/prevention system utilizing micro-policies will be discussed and described. The illustrated components include a dispatcher 301, an attribute table 303, a micro-policies table 305, and a flow table list 307.

The attribute table 303 includes an attribute table entry 331, which indicates an ip address, and attributes such as an operating system and protocol for that specific ip address, as well as any other attributes associated with the target at the ip address which have been collected. In this example, the ip address is 10.1.1.1, the operating system is Linux, the hops between source and destination is “2”, the protocol is tcp/22, and the web server is Apache. The attribute table 303 also contains attribute table entries with attributes collected about other ip addresses 333.

The micro-policies table 305 indicates rules that are specific to at least some of the attributes listed in the attribute table 303. In this example, the micro-policies table 305 indicates rules that are specific to particular operating systems (here represented by Linux 307 and Win32 309), protocols (here represented by SSH 311), and web servers (here represented by Apache 313 and IIS 315).

An item in the flow table list 307 includes an entry 317 and a flow table 319 for currently active flows. This flow table list includes only one item, representing only one active flow. The entry 317 contains an identification of the flow. The flow table 319 contains an identification of rules specific to the flow.

The dispatcher 301 obtains a packet or ip address from a packet. Advantageously, the dispatcher 301 handles one representative packet per flow. Based on the ip address from the packet, the dispatcher 301 looks up 321, in the attribute table 303, the attribute table entry 331 for the ip address, including the attributes for that specific ip address. Then, using the attributes for that specific ip address, the dispatcher 301 checks in the micro-policies table 305 whether there are rules for each of those attributes for that specific ip address.

Optionally, a fast pattern matcher can be utilized to locate the micro-policies in the micro-policies table 305 that match the attributes. Accordingly, one or more embodiments includes performing a matching via a fast pattern matcher with a subset of possible detections utilizing a finite state machine to determine the attack prevention/detection rules which are relevant to the target of the particular flow.

In this illustration, the dispatcher 301 selects, as the rules to be included in the micro-policy for the flow, an indication 323 of the rules specific to Linux 307 and an indication 325 of the rules specific to Apache 313. The dispatcher then inserts into the flow table list 307 an entry 317 identifying this particular flow and the flow table 319 with just the rules selected to be in the micro-policy.

Accordingly, in one or more embodiments there are plural micro-policies, the micro-policies utilizing an attribute table with plural entries indicating: an internet protocol (ip) address, an operating system, a protocol, and a micro-policy that is to be bound for the ip address, the operating system, and the protocol. The micro-policies in the attribute table are addressable by the ip address. The selecting of the rules includes addressing the attribute table by the ip address in transmissions in the particular flow to locate the micro-policy indicated in the attribute table that is to be bound, wherein the located micro-policy is used as the selected micro-policy.

In this manner, the flow table list 307 can be addressed based on the entry indicating the particular flow, and the flow table 319 can be referenced to obtain the rules specific to the particular flow. The rules specific to the particular flow can then be provided to an IDS (not illustrated), to be applied to packets in the flow. Advantageously, the dispatcher 301 can be launched by the engine thread (205, discussed in connection with FIG. 2).

Thereby, the IDS applies only those rules specific to the flow, to the packets which are in the flow, thus significantly reducing the number of rules which are to be applied to each packet and reducing the false positives. In addition, it is more efficient for the dispatcher 301 to determine which rules to apply utilizing the attribute table 303 look-up, the micro-policies table 305 look-up, and to store the rules for those micro-policies in the flow table list 307, than for the IDS to apply an unrestricted set of rules to the packets. Furthermore, the efficiency is increased since the dispatcher 301 determines the micro-policies to be used based on flows, rather than per packet.

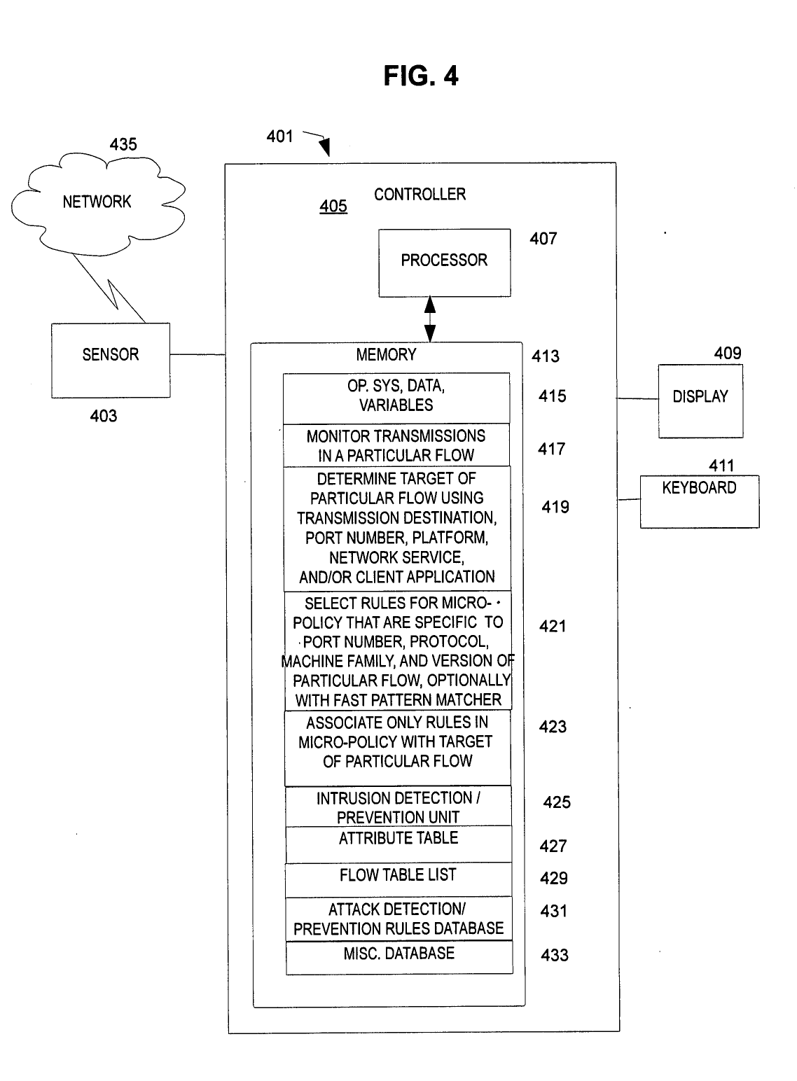

Referring now to FIG. 4, a block diagram illustrating portions of an exemplary computer system will be discussed and described. The computer system 401 may include one or more controllers 405, which can receive signals from a sensor 403 that senses communications from a network 435 in accordance with known techniques, where the communications are being sent to a destination (not illustrated). The controller 405 can include a processor 407, a memory 413, an optional display 409, and/or an optional user input device such as a keyboard 411.

The processor 407 may comprise one or more microprocessors and/or one or more digital signal processors. The memory 413 may be coupled to the processor 407 and may comprise a read-only memory (ROM), a random-access memory (RAM), a programmable ROM (PROM), and/or an electrically erasable read-only memory (EEPROM). The memory 413 may include multiple memory locations for storing, among other things, an operating system, data and variables 415 for programs executed by the processor 407; computer programs for causing the processor to operate in connection with various functions such as monitoring 417 transmissions in a particular flow, determining 419 a target of a particular flow, selecting 421 rules for a micro-policy specific to the flow, associating 423 rules in the micro-policy with the flow, an optional intrusion detection/prevention unit 425, and/or other processing; an attribute table 427; a flow table list 429; a data base of attack detection/prevention rules 431; and a database 433 for other information used by the processor 407. The computer programs may be stored, for example, in ROM or PROM and may direct the processor 407 in controlling the operation of the computer system 401.

The processor 407 can be programmed to monitor 417 transmissions that are received in a particular flow. For example, packets that are detected via the sensor 403 can be reviewed to determine one of the existing flows to which they belong, or to determine that they belong to a new flow. Accordingly, in one or more embodiments, the transmissions are received in accordance with a TCP layer, and the monitoring is performed in accordance with the TCP layer.

The processor 407 may be programmed for determining 419 a target of a particular flow, using the destination (e.g., ip address) and port number specified in packets in the flow, as well as using information that was previously collected such as platform, network service, client application, and/or other information associated with the ip address. The previously collected information may be listed as an attribute(s) in the attribute table 427, as described above. Thereby, the rules which are selected can be further are limited to a network service associated with the particular flow, client application, and/or other information associated with the ip address. Accordingly, one or more embodiments can include a monitor unit configured to facilitate monitoring transmissions in a particular flow.

The processor 407 may be programmed for binding a micro-policy to a target of the particular flow, based on the monitored transmissions. Binding includes both selecting 421 the rules for the micropolicy, and associating 423 only those rules with the target of the particular flow.

Thus, the processor 407 can be programmed for selecting 421 rules for a micro-policy specific to the flow. In this example the rules that are selected for the micro-policy are specific to the port number, the protocol, the machine family, and the version associated with the flow. That is to say, the micro-policy is a set of those rules in the attack detection/prevention rules database 431 specific to the attributes of the particular flow, and excluding those rules that are not used in connection with the attributes of the particular flow.

Also, the processor 407 maybe programmed for associating 423 only the rules that are selected as the micro-policy with the target of the particular flow. For example, the flow can be identified, and associated with an indication of the rules that were selected as the micro-policy. The indication can be, for example, an identifier of the rule, a pointer to the rule, a particular rule, or something else that indicates a specific rule in the attack detection/prevention rules database 431.

Accordingly, one or more embodiments can include a binder unit configured for binding a micro-policy to a target of the particular flow based on the monitored transmissions.

The optional intrusion detection/prevention unit 425 in the processor 407 can be programmed in accordance with known techniques, to evaluate whether the segments suggest an attempted intrusion. The rules in a micro-policy for a particular flow, determined as explained above, can be provided to the intrusion detection/prevention unit 425. The intrusion detection/prevention unit 425 can then apply only the rules in the micro-policy to packets in the particular flow. The intrusion detection/prevention unit 425 is illustrated as being incorporated into the computer system 401; alternate embodiments can provide that some or all of the intrusion detection/prevention functions are in one or more different computer systems. Further, alternate embodiments provide that the intrusion detection/prevention unit 425 is a host IDS (intrusion detection system) or host IPS (intrusion prevention system); thus the computer system itself can, at times, be the destination.

Accordingly, one or more embodiments includes an application unit configured to facilitate applying the micro-policy to the target to detect/prevent an intrusion in the particular flow according to the micro-policy rules which were bound to the target of the particular flow,

The processor 407 may be programmed to include an attribute table 427, a flow table list 429, and a database of attack detection/prevention rules 431. Optionally, the attribute table 427, and/or the database of attack detection/prevention rules 431 can be maintained remotely, and relevant information in the attribute table 427 and/or attack detection/prevention rules 431 can be downloaded as needed. The attribute table 427 can store attributes associated with a target, as discussed above. The database of attack detection/prevention rules 431 contains all of the rules which are available to the processor 407, and are intended to cover all possible attack situations. The flow table list 429 can have entries for each particular flow, with each entry indicating only the rules which are to be applied to packets in the particular flow.

Optionally, entries can be indicated in a table rather than a database, or vice versa. It should be understood that various logical groupings of functions are described herein. Different realizations may omit one or more of these logical groupings. Likewise, in various realizations, functions may be grouped differently, combined, or augmented. Furthermore, functions including those identified as optional can be omitted from various realizations. Similarly, the present description may describe or suggest a database or collection of data and information. One or more embodiments can provide that the database or collection of data and information can be distributed, combined, or augmented, or provided locally (as illustrated) and/or remotely (not illustrated).

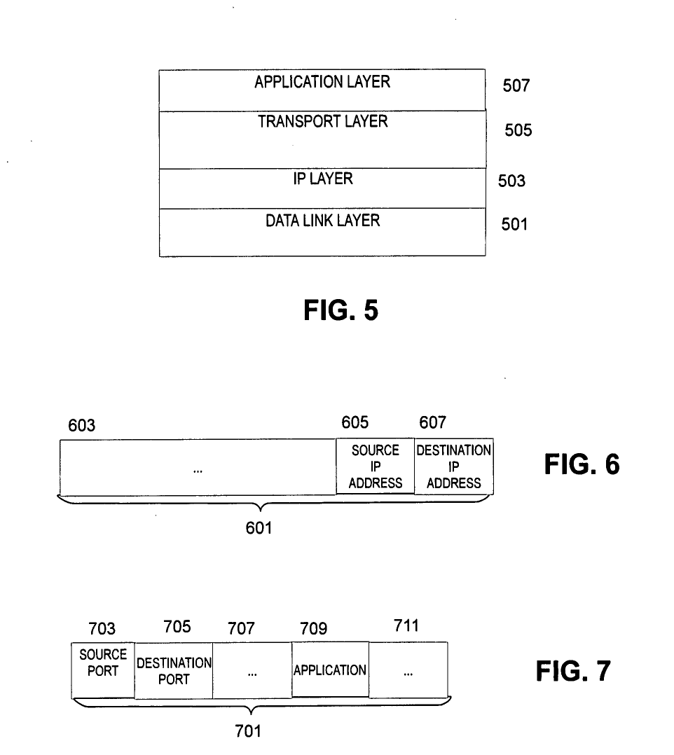

FIG. 5, FIG. 6 and FIG. 7 illustrate relevant conventions associated with TCP layer processing. FIG. 5 illustrates transport layer processing (sometimes referred to as “TCP layer” processing); FIG. 6 illustrates relevant portions of an Internet protocol (IP) header of a packet; and FIG. 7 illustrates relevant portions of a TCP header of a packet.

Referring now to FIG. 5, a block diagram illustrating TCP/IP layer processing will be discussed and described. This example illustrates a data link layer 501, an IP layer 503, a transport layer 505, and an application layer 3507 which operate on a destination. A packet is received by the destination and processed in accordance with known means at the various layers. For example, an incoming packet is initially received at the data link layer 501; passed to the IP layer 503; passed to the transport layer 505; and then sequentially passed to layers above for additional processing.

Conventions associated with the data link layer 501, the IP layer 503, the transport layer 505 and the application layer 507, and the like are well known. In particular, conventions for formats and protocols of transmissions and of packets in accordance with the transport layer are well known. The packets can be monitored and/or received in accordance with the transport layer protocol, that is, the packets are interpreted in accordance with the transport layer protocol and its formats; more particularly, the transport layer protocol can be a TCP layer protocol. Typically, a target is determined by processing at the transport layer 505. Accordingly, one or more embodiments provide that the monitoring is performed in accordance with a TCP layer.

Referring now to FIG. 6, a block diagram illustrating portions of an Internet protocol (IP) header in a segment will be discussed and described. The illustrated IP header 601 is a portion of a transmission formatted according to the IP layer, which also includes data. The IP header 601 includes an indication of the source IP address 605, and an indication of the destination IP address 607. Other fields 603 typically are included in the IP header 601. These fields are well defined in various industry specifications, as may be modified from time-to-time.

The destination IP address 607 uniquely identifies the system for which the transmission is destined. The source IP address 605 uniquely identifies the system that originated the transmission.

Referring now to FIG. 7, a block diagram illustrating portions of a TCP header in a segment will be discussed and described. Portions of the conventional TCP header 701 which can be referenced include a source port 703, a destination port 706, application 709, and miscellaneous other fields 707, 711. These fields also are well defined in various industry specifications, as may be modified from time-to-time.

A flow is specific not only to source and destination IP addresses, but also to source port 703 and destination port 705. Packets in the same flow also will have the same application 709. Thus, the source IP address, the destination IP address, source port 703, destination port 705, or application 709, are the same for packets in a particular flow. Methods are known for determining a flow to which packets belong, as well as for determining when a flow begins and ends.

In this example, the IP packet including the IP header 701 is wrapped around the TCP packet at the IP layer processing before being transmitted. Hence, a packet in a transmission that is monitored will include both the IP header 701 and the TCP header (illustrated in FIG. 6). The attribute table can include information expressly indicated in IP packets as well as information that has been passively or actively collected or manually indicated (such as machine, operating system and version, etc.) which is specific to a target (such as a particular ip address, and/or port and/or application) but not explicitly indicated in the IP packet.

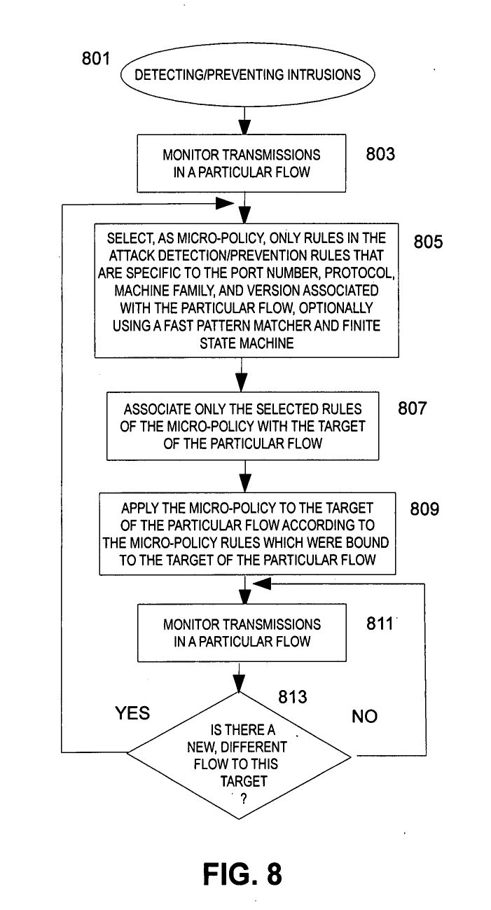

Referring now to FIG. 8, a flow chart illustrating an exemplary procedure for detecting/preventing intrusions will be discussed and described. The process can conveniently be implemented on a computer system, such as illustrated in connection with FIG. 4, or other computer system appropriately arranged.

In overview, the process 801 can include monitoring 803 transmissions in a particular flow, selecting 805 rules to be included in the micro-policy, associating 807 only the selected rules with the target of the particular flow, and applying 809 the micro-policy to the target of the particular flow. Flows can come and go. Thus, even after the micro-policy is set up, the process 801 continues to monitor 811 transmissions in a particular flow. When there is a new, different flow to the target, the procedure can loop to select 805 a different micro-policy, and repeat. These are discussed in more detail below; however, detail is omitted if it has been previously discussed.

The process 801 can include monitoring 803 transmissions in a particular flow, for example as described above. As discussed above, packets that are received can be monitored to determine the flow to which they belong, and/or to determine if there is a new, different flow. Also as explained above, the content of the packets can be examined for other purposes as well.

The process 801 can include selecting 805 rules to be included in the micro-policy. The only rules in the attack detection/prevention rules that are selected are those that are specific to the attributes (for example, the port number, protocol, machine family, and version) of the destination ip address associated with the particular flow. The rules which are selected can be determined from the content of the packet and/or from attribute information previously collected about the destination but which is not explicitly indicated in any packet.

The process 801 can include associating 807 only the selected rules with the target of the particular flow. For example, a flow table list can be maintained which identifies the particular flow and the selected rules, as described above. Accordingly, those selected rules are “bound” to the target of the particular flow. Note that any individual rule can be included in multiple micro-policies, because it is possible for multiple flows to have one or more attributes which are the same. For example, the same operating system can be used on different targets; hence, the micro-policies for those different targets would include the rules specific to the same operating system. The designation “target” can mean the particular port at the particular ip address, but may be more specific, such as particular application on the port at the ip address.

The functions of selecting 805 rules to be included in the micro-policy and associating 807 only the selected rules with the target of a particular flow are collectively referred to as “binding” a micro-policy to a target of a particular flow.

The process 801 can include applying 809 the micro-policy to the target of the particular flow. That is, potential intrusions in the particular flow are detected using the micro-policy bound to the particular flow, but not the other attack detection/prevention rules.

Accordingly, one or more embodiments provides a method performed in an intrusion detection/prevention system, a computer system, and/or a computer readable medium, with such method, for associating attack detection/prevention rules with a target in a communication network, for a particular flow, wherein the attack detection/prevention rules are provided for the target without differentiation as to flows, wherein a particular flow is associated with a transmission destination, a port number, a platform, a network service, or a client application on the target. Transmissions in a particular flow are monitored. A micro-policy is bound to a target of the particular flow based on the monitored transmissions. The micro-policy is applied to the target to detect an intrusion in the particular flow according to the micro-policy rules which were bound to the target of the particular flow. Binding the micro-policy includes selecting, as the micro-policy, only rules in the attack detection/prevention rules that are specific to the port number, the protocol, the family of machine, and the version associated with the particular flow, and associating only the selected rules of the micro-policy with the target of the particular flow, for example, as an entry and a flow table in a flow table list.

Even after the micro-policy is bound to the particular flow, transmissions in the particular flow continued to be monitored 811. The process 801 checks, for example in packets between the source and destination of the flow, whether there is a new, different flow to the target, 813. A determination of whether there is a new flow can be performed in accordance with conventional techniques. If there is a new, different flow, then the process 801 loops to select a new micro-policy to be bound to the new, different flow. If a particular flow is terminated, its entry and flow table can be removed from the flow table list.

Accordingly, one or more embodiments can include binding a new micro-policy to the target when there is a new flow to the target.

Moreover, one or more embodiments provides a computer-readable medium comprising instructions being executed by a computer, the instructions including a computer-implemented method for associating attack detection/prevention rules with a target in a communication network, for a particular flow, wherein the attack detection/prevention rules are provided for the target without differentiation as to flows, wherein a particular flow is associated with a transmission destination, a port number, a platform, a network service, or a client application on the target, the instructions for implementing the foregoing method.

It should be noted that the communication networks of interest include those that transmit information in packets, for example, those known as packet switching networks that transmit data, where data can be divided into packets before transmission, the packets are transmitted, and the packets are routed over network infrastructure devices, which are sent to a destination. Such networks include, by way of example, the Internet, intranets, local area networks (LAN), wireless LANs (WLAN), wide area networks (WAN), and others. Protocols supporting communication networks that utilize packets include one or more of various networking protocols having any link layers that support the TCP transport layer, or any application that rides over the transport layer, and other wireless application protocols or wireline application protocols and/or other protocol structures, and variants and evolutions thereof. Such networks can provide wireless communication capability and/or utilize wireline connections such as cable and/or a connector, or similar.

Furthermore, the designation “intrusion detection/prevention system” (IDS) is used herein to denote a device or software that passively or actively analyzes network traffic for intrusion. Examples of such devices or software are sometimes referred to as “intrusion detection system”, “intrusion prevention system”, “network intrusion detection system”, “network intrusion protection system”, and the like, and variants or evolutions thereof. An intrusion detection/prevention system may be host-based, or may monitor traffic to a target system using, for example, sensors, anywhere between the target system and the intruder, typically after a final router or firewall. The designation “intrusion detection/prevention” is used herein to indicate the analysis of network traffic with respect to intrusion, where the analysis is used passively (commonly referred to as “intrusion detection”) or actively (commonly referred to as “intrusion prevention”). Likewise, the designation “detect/prevent” is utilized to indicate either passive or active handling or intrusion, which may occur for example in an intrusion detection system, an intrusion prevention system, or other software or device which incorporates an intrusion detection/prevention function, such as a firewall, proxy, or the like.

Also, the designation “flow” as used herein (except for the designation “flow chart”) indicates a series of packets between two different endpoints, where the packets share pre-defined properties, and is sometimes referred to as a “packet train”. The pre-defined properties that are shared by the packets in a particular flow typically are the source and destination IP address, and source and destination port. Other attributes further can be used to identify a flow, such as other properties that are shared between packets, packets signifying start or end of transmission, and/or a pre-defined elapsed time between packets suggesting termination of a flow, as definitions of flows may be adapted and modified from time-to-time.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method performed in an intrusion detection/prevention system, for associating attack detection/prevention rules with a target in a communication network, for a particular flow, wherein the attack detection/prevention rules are provided for the target without differentiation as to flows, wherein a particular flow is associated with a transmission destination, a port number, a platform, a network service, or a client application on the target, comprising:
monitoring transmissions in a particular flow;
binding a micro-policy to a target of the particular flow based on the monitored transmissions; and
applying the micro-policy to the target to detect an intrusion in the particular flow according to the micro-policy rules which were bound to the target of the particular flow,
wherein binding the micro-policy includes selecting, as the micro-policy, only rules in the attack detection/prevention rules that are specific to the port number, the protocol, the family of machine, and the version associated with the particular flow, and associating only the selected rules of the micro-policy with the target of the particular flow.

2. The method according to claim 1, further comprising binding a new micro-policy to the target when there is a new flow to the target.

3. The method according to claim 1, wherein there are plural micro-policies, the micro-policies utilizing an attribute table with plural entries indicating:
an internet protocol (ip) address, an operating system, a protocol, and a micro-policy that is to be bound for the ip address, the operating system, and the protocol,
wherein the micro-policies in the attribute table are addressable by the ip address,
wherein the selecting includes addressing the attribute table by the ip address in transmissions in the particular flow to locate the micro-policy indicated in the attribute table that is to be bound, wherein the located micro-policy is used as the selected micro-policy.

4. The method according to claim 1, wherein the rules which are selected further are limited to a network service associated with the particular flow.

5. The method according to claim 1, wherein the monitoring is performed in accordance with a TCP layer.

6. The method according to claim 1, further comprising performing a matching via a fast pattern matcher with a subset of possible detections utilizing a finite state machine to determine the attack prevention/detection rules which are relevant to the target of the particular flow.

7. The method according to claim 1, wherein the applying includes forwarding the rules in the micro-policy to an intrusion detection/prevention engine.

8. A computer-readable medium comprising instructions being executed by a computer, the instructions including a computer-implemented method for associating attack detection/prevention rules with a target in a communication network, for a particular flow, wherein the attack detection/prevention rules are provided for the target without differentiation as to flows, wherein a particular flow is associated with a transmission destination, a port number, a platform, a network service, or a client application on the target, the instructions for implementing:
monitoring transmissions in a particular flow;
binding a micro-policy to a target of the particular flow based on the monitored transmissions; and
applying the micro-policy to the target to detect an intrusion in the particular flow according to the micro-policy rules which were bound to the target of the particular flow,
wherein binding the micro-policy includes selecting, as the micro-policy, only rules in the attack detection/prevention rules that are specific to the port number, the protocol, the family of machine, and the version associated with the particular flow, and associating only the selected rules of the micro-policy with the target of the particular flow.

9. The computer-readable medium according to claim 8, further comprising instructions for binding a new micro-policy to the target when there is a new flow to the target.

10. The computer-readable medium according to claim 8, wherein there are plural micro-policies, the micro-policies utilizing an attribute table with plural entries indicating:
an internet protocol (ip) address, an operating system, a protocol, and micro-policy that is to be bound for the ip address, the operating system, and the protocol,
wherein the micro-policies in the attribute table are addressable by the ip address,
wherein the selecting includes addressing the attribute table by the ip address in transmissions in the particular flow to locate the micro-policy indicated in the attribute table that is to be bound, wherein the located micro-policy is used as the selected micro-policy.

11. The computer-readable medium according to claim 8, wherein the rules which are selected further are limited to a network service associated with the particular flow.

12. The computer-readable medium according to claim 8, wherein the monitoring is performed in accordance with a TCP layer.

13. The computer-readable medium according to claim 8, further comprising instructions for performing a matching via a fast pattern matcher with a subset of possible detections utilizing a finite state machine to determine the attack prevention/detection rules which are relevant to the target of the particular flow.

14. The computer-readable medium according to claim 8, wherein the applying includes forwarding the rules in the micro-policy to an intrusion detection/prevention engine.

15. A computer system for detecting or preventing intrusions, for use with attack detection/prevention rules, with a target in the communication network, for a particular flow, wherein the attack detection/prevention rules are provided for the target without differentiation as to flows, wherein a particular flow is associated with a transmission destination, a port number, a platform, a network service, or a client application on the target, comprising:
a monitor unit configured to facilitate monitoring transmissions in a particular flow;
a binder unit configured for binding a micro-policy to a target of the particular flow based on the monitored transmissions; and
an application unit configured to facilitate applying the micro-policy to the target to detect/prevent an intrusion in the particular flow according to the micro-policy rules which were bound to the target of the particular flow,
wherein binding the micro-policy includes selecting, as the micro-policy, only rules in the attack detection/prevention rules that are specific to the port number, the protocol, the family of machine, and the version associated with the particular flow, and associating only the selected rules of the micro-policy with the target of the particular flow.

16. The computer system according to claim 15, wherein the binder unit is further configured to bind a new micro-policy to the target when there is a new flow to the target.

17. The computer system according to claim 15, wherein there are plural micro-policies, the micro-policies utilizing an attribute table with plural entries indicating:
an internet protocol (ip) address, an operating system, a protocol, a micro-policy that is to be bound for the ip address, the operating system and the protocol,
wherein the micro-policies in the attribute table are addressable by the ip address,
wherein the selecting includes addressing the attribute table by the ip address in transmissions in the particular flow to locate the micro-policy indicated in the attribute table that is to be bound, wherein the located micro-policy is used as the selected micro-policy.

18. The computer system according to claim 15, wherein the rules which are selected further are limited to a network service associated with the particular flow.

19. The computer system according to claim 15, further comprising a receiving unit configured to facilitate receiving transmissions, wherein
the transmissions are received in accordance with a TCP layer, and the monitoring is performed in accordance with the TCP layer.

20. The computer system according to claim 15, wherein the selecting is performed by a fast pattern matcher with a subset of possible detections utilizing a finite state machine to determine the attack prevention/detection rules which are relevant to the target of the particular flow.
